(19) United States
(12) Patent Application Publication
(10) Pub. No.: US 2026/0176062 A1
(43) Pub. Date: Jun. 25, 2026

(54) OPERATING A PACKER TO PACK REFUSE WITHIN A STORAGE CONTAINER OF A REFUSE COLLECTION VEHICLE

(71) Applicant: The Heil Co., Chattanooga, TN (US)

(72) Inventor: Jesus Alejandro de Leon Tello, Fort Payne, AL (US)

(21) Appl. No.: 19/423,974

(22) Filed: Dec. 17, 2025

Related U.S. Application Data
(60) Provisional application No. 63/736,508, filed on Dec. 19, 2024.

(51) Int. Cl. B65F 3/20

(52) U.S. Cl. CPC B65F 3/201; B65F 2210/12; B65F 2210/128; B65F 2210/162

(57) ABSTRACT

Refuse collection vehicles and methods of operating refuse collection vehicles are disclosed. A method includes: receiving, by a control system, data generated by a communication system configured to transmit and receive electromagnetic energy, the communication system comprising: a first communication device attached to a wall of a storage container of the refuse collection vehicle; and a second communication device attached to a surface of a packer of the refuse collection vehicle and facing the wall of the storage container; determining, by the control system and based on the data generated by the communication system, a distance between the packer and the wall of the storage container; and adjusting, by the control system and based on the distance between the packer and the wall, one or more operating parameters of an actuator coupled to the packer and configured to exert a force on the packer to move the packer.

### CROSS-REFERENCE TO RELATED APPLICATION

This application claims the benefit of the U.S. Provisional Patent Application No. 63/736,508, filed Dec. 19, 2024, which is incorporated herein by reference in its entirety.

### TECHNICAL FIELD

This disclosure relates to systems and methods for operating a packer of a refuse collection vehicle.

### BACKGROUND

Refuse collection vehicles collect solid waste and transport the solid waste to landfills, recycling centers, or treatment facilities. A packer within a storage container of a refuse collection vehicle packs the refuse in order to reduce a volume of the refuse and to increase an amount of refuse that can be carried by the vehicle.

### SUMMARY

Implementations of the present disclosure are generally related to refuse collection vehicles including a packer disposed inside a storage container. The packer can be moved by one or more actuators in order to compress refuse and/or to reject refuse from the storage container. The refuse collection vehicles can include a communication system of wireless sensors configured to measure a position of a packer within the storage container. The wireless sensors can include a communication system with at least two elements. Each element can be a transmitter, a receiver, or a transceiver. In some examples, the wireless sensors transmit and receive ultra-wide band electromagnetic energy.

The wireless sensors can measure the distance of the packer from a fixed location, such as a front wall of the storage container. Operation of the actuators can be adjusted based on the measured position of the packer. For example, pressure settings of the actuators can be reduced as the packer moves further from the front wall of the storage container in order to avoid overextending the actuators.

In an example implementation, a method of operating a refuse collection vehicle includes: receiving, by a control system, data generated by a communication system configured to transmit and receive electromagnetic energy, the communication system including: a first communication device attached to a wall of a storage container of the refuse collection vehicle; and a second communication device attached to a surface of a packer of the refuse collection vehicle and facing the wall of the storage container; determining, by the control system and based on the data generated by the communication system, a distance between the packer and the wall of the storage container; and adjusting, by the control system and based on the distance between the packer and the wall, one or more operating parameters of an actuator coupled to the packer and configured to exert a force on the packer to move the packer.

In an aspect combinable with the example implementation, adjusting the one or more operating parameters of the actuator includes controlling the actuator to exert a force on the packer below a threshold force when the distance between the packer and the wall of the storage container is greater than a threshold distance.

In another aspect combinable with any of the previous aspects, adjusting one or more operating parameters of the actuator includes controlling the actuator to exert a force on the packer below a threshold force when the distance between the packer and the wall of the storage container is less than a threshold distance.

In another aspect combinable with any of the previous aspects, the method includes operating the actuator to exert a first force on the packer; receiving, by the control system from the communication system, updated data; determining, by the control system and based on the updated data, a distance traveled by the packer; determining that the distance traveled by the packer satisfies a threshold distance; and in response to determining that the distance traveled by the packer satisfies the threshold distance, operating the actuator to exert a second force on the packer, the second force being less than the first force.

In another aspect combinable with any of the previous aspects, the distance traveled by the packer includes a distance traveled by the packer during a single displacement from the wall of the storage container.

In another aspect combinable with any of the previous aspects, the distance traveled by the packer includes a distance traveled by the packer during multiple displacements from the wall of the storage container.

In another aspect combinable with any of the previous aspects, the first communication device includes a first radio frequency transceiver and the second communication device includes a second radio frequency transceiver.

In another aspect combinable with any of the previous aspects, the first communication device includes a radio frequency transmitter and the second communication device includes a radio frequency receiver.

In another aspect combinable with any of the previous aspects, the first communication device includes a radio frequency receiver and the second communication device includes a radio frequency transmitter.

In another aspect combinable with any of the previous aspects, the communication system is configured to transmit and receive ultra-wide band frequency electromagnetic energy.

In another aspect combinable with any of the previous aspects, the electromagnetic energy has a frequency between 3.0 GHz and 11.0 GHz.

In another aspect combinable with any of the previous aspects, receiving, by the control system, the data generated by the communication system includes: receiving, from the communication system, data indicating a time duration between electromagnetic energy transmission and electromagnetic energy receipt.

In another aspect combinable with any of the previous aspects, receiving, by the control system, the data generated by the communication system includes: receiving, from the communication system, data indicating a time duration between: transmission of electromagnetic energy from the second communication device to the first communication device; and receipt of electromagnetic energy by the second communication device from the first communication device.

In another aspect combinable with any of the previous aspects, the first communication device includes a first ultra-wide band transceiver; the second communication device includes a second ultra-wide band transceiver; the first ultra-wide band transceiver is configured to transmit electromagnetic energy to the second ultra-wide band transceiver; and the second ultra-wide band transceiver is configured to transmit, to the control system, time data associated with the electromagnetic energy.

In another aspect combinable with any of the previous aspects, the actuator includes a hydraulic actuator; the refuse collection vehicle further includes a valve system fluidly coupled to the actuator; and adjusting the one or more operating parameters of the actuator includes controlling, by the controller, a pressure of hydraulic fluid in the actuator to alter the force exerted by the hydraulic actuator on the packer.

In another aspect combinable with any of the previous aspects, adjusting the one or more operating parameters of the actuator includes adjusting a setting of a pressure relief valve of the valve system based on the distance of the packer from the wall.

In another aspect combinable with any of the previous aspects, the actuator includes a linear actuator.

In another aspect combinable with any of the previous aspects, the method includes operating, by the control system, two or more actuators based on the distance between the packer and the wall.

In another aspect combinable with any of the previous aspects, the actuator is coupled to the wall of the storage container and to the surface of the packer.

In another aspect combinable with any of the previous aspects, the actuator includes an electric actuator or a hydraulic actuator.

In another example implementation, a refuse collection vehicle includes: a wheeled chassis; a storage container supported on the wheeled chassis; a packer disposed within the storage container; an actuator coupled to the packer and configured to exert a force on the packer to move the packer; a communication system configured to generate data indicating a distance of the packer from a wall of the storage container, the communication system including: a first communication device attached to the wall of the storage container; and a second communication device attached to a surface of the packer and facing the wall of the storage container; and a control system configured to receive, as input, the data indicating the distance of the packer from the wall of the storage container and to adjust one or more operating parameters of the actuator based on the distance between the packer and the wall of the storage container.

In an aspect combinable with the example implementation, adjusting the one or more operating parameters of the actuator includes controlling the actuator to exert a force on the packer below a threshold force when the distance between the packer and the wall of the storage container is greater than a threshold distance.

In another aspect combinable with any of the previous aspects, adjusting the one or more operating parameters of the actuator includes controlling the actuator to exert a force on the packer below a threshold force when the distance between the packer and the wall of the storage container is less than a threshold distance.

In another aspect combinable with any of the previous aspects, the control system is configured to: operate the actuator to exert a first force on the packer; receive, by the control system from the communication system, updated data; determine, by the control system and based on the updated data, a distance traveled by the packer; determine that the distance traveled by the packer satisfies a threshold distance; and in response to determining that the distance traveled by the packer satisfies the threshold distance, operate the actuator to exert a second force on the packer, the second force being less than the first force.

In another aspect combinable with any of the previous aspects, the distance traveled by the packer includes a distance traveled by the packer during a single displacement from the wall of the storage container.

In another aspect combinable with any of the previous aspects, the distance traveled by the packer includes a distance traveled by the packer during multiple displacements from the wall of the storage container.

In another aspect combinable with any of the previous aspects, the first communication device includes a first radio frequency transceiver and the second communication device includes a second radio frequency transceiver.

In another aspect combinable with any of the previous aspects, the first communication device includes a radio frequency transmitter and the second communication device includes a radio frequency receiver.

In another aspect combinable with any of the previous aspects, the first communication device includes a radio frequency receiver and the second communication device includes a radio frequency transmitter.

In another aspect combinable with any of the previous aspects, the communication system is configured to transmit and receive ultra-wide band frequency electromagnetic energy.

In another aspect combinable with any of the previous aspects, the communication system is configured to transmit and receive electromagnetic energy having a frequency between 3.0 GHz and 11.0 GHz.

In another aspect combinable with any of the previous aspects, the communication system is configured to transmit and receive electromagnetic energy; and receiving, by the control system, the data indicating the distance between the packer and the wall of the storage container includes: receiving, from the communication system, data indicating a time duration between electromagnetic energy transmission and electromagnetic energy receipt.

In another aspect combinable with any of the previous aspects, the first communication device includes a first ultra-wide band transceiver; the second communication device includes a second ultra-wide band transceiver; the first ultra-wide band transceiver is configured to transmit electromagnetic energy to the second ultra-wide band transceiver; and the second ultra-wide band transceiver is configured to transmit, to the control system, time data associated with the electromagnetic energy.

In another aspect combinable with any of the previous aspects, the actuator includes a hydraulic actuator; the refuse collection vehicle further includes a valve system fluidly coupled to the actuator; and adjusting the one or more operating parameters of the actuator includes controlling, by the controller, a pressure of hydraulic fluid in the actuator to alter the force exerted by the hydraulic actuator on the packer.

In another aspect combinable with any of the previous aspects, adjusting the one or more operating parameters of the actuator includes adjusting a setting of a pressure relief valve of the valve system based on the distance of the packer from the wall.

In another aspect combinable with any of the previous aspects, the actuator includes a linear actuator.

In another aspect combinable with any of the previous aspects, the control system is configured to adjust operating parameters of two or more actuators based on the distance between the packer and the wall.

In another aspect combinable with any of the previous aspects, the actuator is coupled to the wall of the storage container and to the surface of the packer.

In another aspect combinable with any of the previous aspects, the actuator includes an electric actuator or a hydraulic actuator.

In another example implementation, a method of operating a refuse collection vehicle includes: receiving, by a control system from a communication system, data indicating time-varying distance of a packer of the refuse collection vehicle from a wall of a storage container of the refuse collection vehicle, the communication system including: a first communication device attached to the wall of the storage container; and a second communication device attached to a surface of the packer and facing the wall of the storage container; determining, by the control system and based on the received data, a distance traveled by the packer over a time duration; and adjusting, by the control system and based on the distance traveled by the packer over the time duration, one or more operating parameters of an actuator coupled to the packer and configured to exert a force on the packer to move the packer.

In an aspect combinable with the example implementation, adjusting the one or more operating parameters of the actuator includes controlling the actuator to exert a force on the packer below a threshold force when the distance traveled by the packer over the time duration is greater than a threshold distance.

In another aspect combinable with any of the previous aspects, adjusting one or more operating parameters of the actuator includes controlling the actuator to exert a force on the packer below a threshold force when the distance traveled by the packer over the time duration is less than a threshold distance.

In another aspect combinable with any of the previous aspects, the first communication device includes a first radio frequency transceiver and the second communication device includes a second radio frequency transceiver.

In another aspect combinable with any of the previous aspects, the first communication device includes a radio frequency transmitter and the second communication device includes a radio frequency receiver.

In another aspect combinable with any of the previous aspects, the first communication device includes a radio frequency receiver and the second communication device includes a radio frequency transmitter.

In another aspect combinable with any of the previous aspects, the communication system is configured to transmit and receive ultra-wide band frequency electromagnetic energy.

In another aspect combinable with any of the previous aspects, the communication system is configured to transmit and receive electromagnetic energy having a frequency between 3.0 GHz and 11.0 GHz.

In another aspect combinable with any of the previous aspects, the communication system is configured to transmit and receive electromagnetic energy; and receiving, by the control system, the data indicating the time-varying distance of the packer from the wall of the storage container includes: receiving, from the communication system, first data indicating a first time duration between first electromagnetic energy transmission and first electromagnetic energy receipt; and receiving, from the communication system, second data indicating a second time duration between second electromagnetic energy transmission and second electromagnetic energy receipt.

In another aspect combinable with any of the previous aspects, determining, by the control system and based on the received data, the distance traveled by the packer over a time duration includes: determining the distance traveled by the packer between receipt of the first data and receipt of the second data.

In another aspect combinable with any of the previous aspects, the first communication device includes a first ultra-wide band transceiver; the second communication device includes a second ultra-wide band transceiver; the first ultra-wide band transceiver is configured to transmit electromagnetic energy to the second ultra-wide band transceiver; and the second ultra-wide band transceiver is configured to transmit, to the control system, time data associated with the electromagnetic energy.

In another aspect combinable with any of the previous aspects, the actuator includes a hydraulic actuator; the refuse collection vehicle further includes a valve system fluidly coupled to the actuator; and adjusting the one or more operating parameters of the actuator includes controlling, by the controller, a pressure of hydraulic fluid in the actuator to alter the force exerted by the hydraulic actuator on the packer.

In another aspect combinable with any of the previous aspects, adjusting the one or more operating parameters of the actuator includes adjusting a setting of a pressure relief valve of the valve system based on the distance traveled by the packer over the time duration.

In another aspect combinable with any of the previous aspects, the actuator includes a linear actuator.

In another aspect combinable with any of the previous aspects, the method includes operating, by the control system, two or more actuators based on the distance traveled by the packer over the time duration.

In another aspect combinable with any of the previous aspects, the actuator is coupled to the wall of the storage container and to the surface of the packer.

In another aspect combinable with any of the previous aspects, the actuator includes an electric actuator or a hydraulic actuator.

Other implementations of any of the above aspects include corresponding systems, apparatus, and computer programs that are configured to perform the actions of the methods, encoded on computer storage devices. The present disclosure also provides a computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

Particular implementations of the subject matter described in this specification may realize one or more of the following advantages. Controlling the actuators based on the real-time position of the packer can prevent over-extending the actuators and damaging the actuators. Controlling the actuators based on the real-time position of the packer can reduce the likelihood of damage to the actuators due to applying excess pressure to the packer, such as when the refuse cannot be further compressed.

Measuring the distance of the packer from the wall of the storage container using ultra-wide band electromagnetic energy reduces the likelihood of interference in measuring the packer position caused by refuse that has fallen between the packer and the wall of the storage container. Ultra-wide band energy is more accurate, faster, and less susceptible to interference compared to other wireless signals used for measuring the movement or position of the packer. Ultra-wide band radio frequency signals can be used to obtain real-time, highly accurate, highly reliable measurements.

It is appreciated that methods in accordance with the present specification may include any combination of the aspects and features described herein. That is, methods in accordance with the present specification are not limited to the combinations of aspects and features specifically described herein, but also include any combination of the aspects and features provided.

The details of one or more implementations of the subject matter described in this disclosure are set forth in the accompanying drawings and the description below. Other features, objects, and advantages of the subject matter will be apparent from the description and drawings, and from the claims.

### DESCRIPTION OF DRAWINGS

FIGS. 1A and 1B are perspective side views of an example refuse collection vehicle.

FIGS. 2A and 2B are perspective and side views of example refuse collection vehicles including actuated body components.

FIGS. 3A and 3B are side views of a refuse collection vehicle with a packer operating to pack refuse within a storage container of the refuse collection vehicle.

FIG. 4 is a block diagram of an example control system of a packer of the refuse collection vehicle.

FIG. 5 is a flow chart of an example method of operating a refuse collection vehicle.

FIG. 6 is a schematic illustration of an example control system or controller of the refuse collection vehicle.

### DETAILED DESCRIPTION

Various embodiments of the present disclosure feature a refuse collection vehicle including a system for detecting a position of a packer within a storage container. A communication system can be installed in the storage container in order to detect the position of the packer and to track movement of the packer by an actuator. Operating parameters of the actuator used to control movement of the packer can be adjusted based on the detected position of the packer. Adjusting operating parameters of the actuator based on the position of the packer can reduce the likelihood of damage to the packer and can extend the lifetime of the packer system.

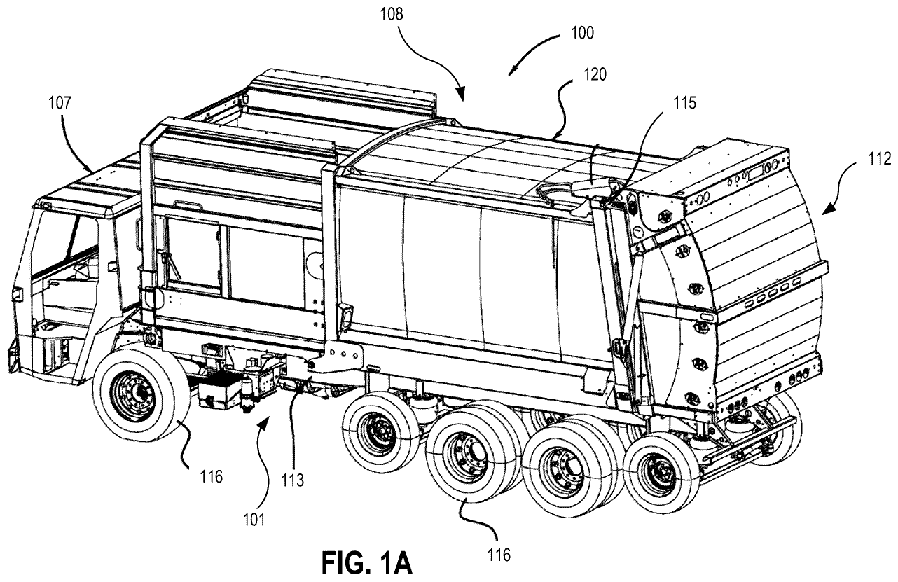

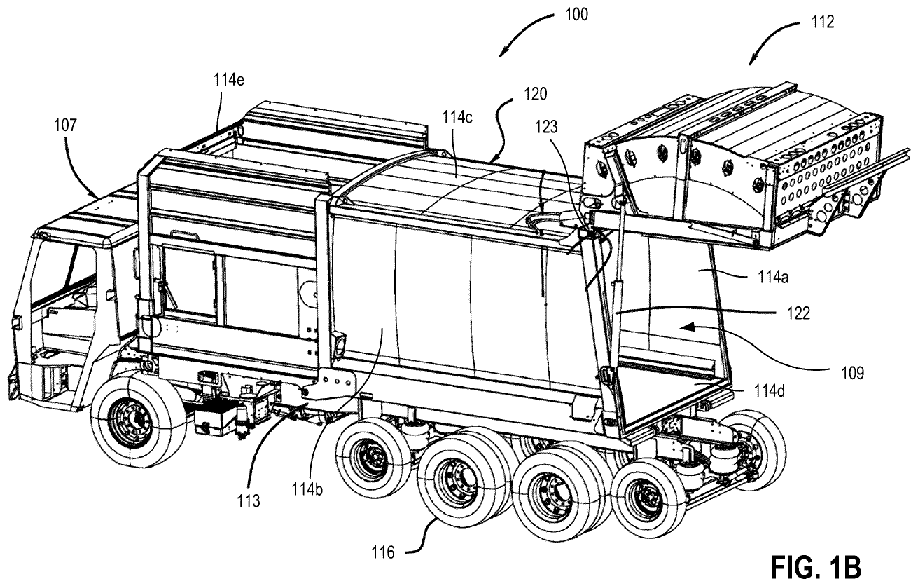

FIGS. 1A-1B depict a refuse collection vehicle 100. The refuse collection vehicle 100 is illustrated as a front loader, but the refuse collection vehicle 100 can be a side loader, a rear loader, or another type of refuse collection vehicle such as a skid-loader, a tele-handler, a plow truck, or a boom lift.

The refuse collection vehicle 100 has a wheeled chassis 101. The wheeled chassis 101 includes a lower frame 113 and road wheels 116 attached to the lower frame 113. The refuse collection vehicle 100 also includes a cabin 107 (e.g., a driver's cab), a refuse collecting body 108 carried by the wheeled chassis 101, and a tailgate 112 coupled to the body 108. Propulsion of the chassis 101 of the refuse collection vehicle 100 can be powered by a variety of types of engines including, but not limited to, an electric engine, a diesel engine, or a compressed natural gas (CNG) engine.

The refuse collecting body 108 has an interior volume 109 between a pair of side walls 114a-b, a top surface 114c (e.g., roof), a floor 114d, and a front wall 114e. The interior volume 109 includes a refuse storage container 120 that receives and stores refuse collected by the refuse collection vehicle 100. A tailgate 112 is secured to the body 108 by hinges 115. The hinges 115 are connected around pivot pins 123 so that the tailgate 112 can rotate with respect to the body 108. The tailgate 112 can be rotated by one or more actuators 122. The actuators 122 can be electric actuators or hydraulic actuators.

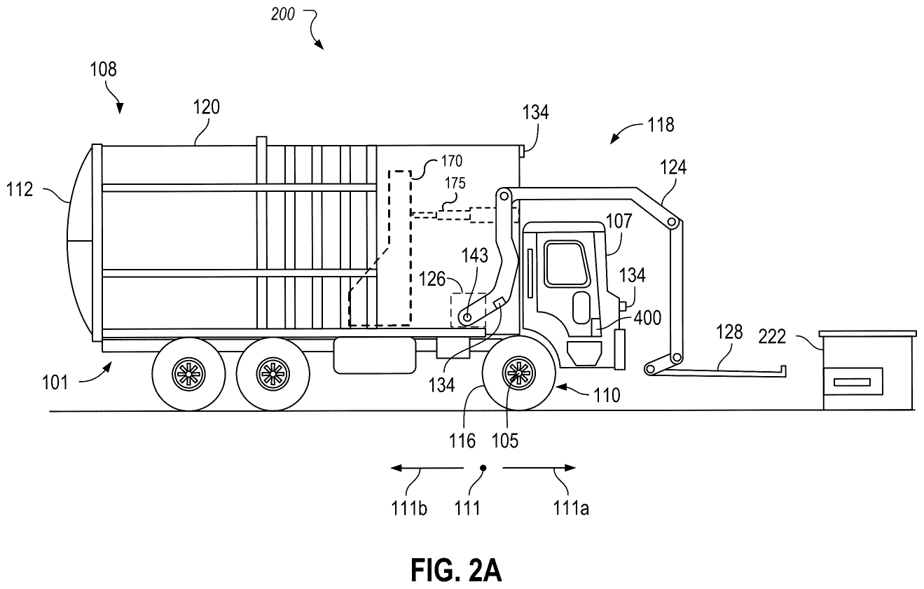

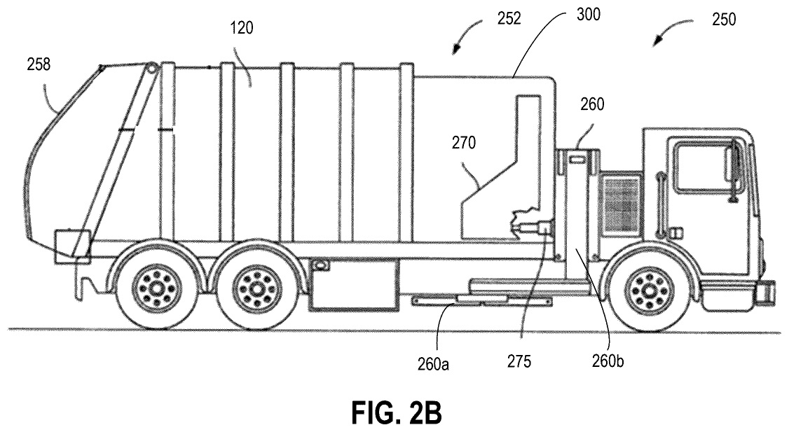

Various electrically or hydraulically actuated body components of refuse collection vehicles 200 and 250 are depicted in FIGS. 2A and 2B. For example, body components can include a lift arm (e.g., 124, 260b), a fork assembly (e.g., 128), a grabber mechanism (e.g., 260a), a back gate or tailgate (e.g., 112, 332), a hopper to collect refuse during operation (e.g., 300), a storage container to contain the refuse after collection (e.g., 120, 366), and a packer (e.g., 170, 270).

FIG. 2A depicts a vehicle 200 for collecting and transporting refuse (e.g., garbage). Refuse collection vehicles such as vehicle 200 are often described colloquially as garbage collection vehicles or just “garbage trucks.”

Refuse collection vehicle 200 includes a cabin 107, a chassis 101, and a refuse collecting body 108. Cabin 107 includes a compartment for a driver of vehicle 200. The compartment is equipped with controls that enable the driver to operate various elements of chassis 101 and body 108. Chassis 101 includes a power train 110 (e.g., a diesel, CNG, or electric power train). Power train 110, which includes a prime mover and a drivetrain, converts and transfers motive power to the wheels 116 that move vehicle 200 on a road surface along a forward direction of travel 111a and a rearward direction of travel 111b. For ease of discussion, we reference the direction across vehicle 200 and orthogonal to the forward/rearward directions as a transverse direction 111.

Vehicle 200 is a front-loading refuse collecting vehicle. Accordingly, refuse collecting body 108, which is coupled to chassis 101, includes a front lift 118 and a storage container 120. Front lift 118 includes an arm assembly 124 driven by an arm actuator 126 and a fork assembly 128 driven by a fork actuator (not shown). Arm assembly 124 rotates pivotally along a pivot axis 143 (which is parallel to transverse direction 111) relative to chassis 101 and storage container 120.

Arm actuator 126 resides proximate the refuse storage container 120, behind cabin 107 and behind the front axle 105 of chassis 101. In this example, at least the majority (e.g., the entirety) of the mass of the arm actuator 126 resides in a limited space that extends no further in transverse direction 111 than the extent of the exterior lateral side walls of storage container 120. Positioning arm actuator 126 in this manner introduces unique space constraints in the sense that the volume envelope of arm actuator 126 may affect the available positioning and size—and therefore storage capacity—of storage container 120.

During use, arm actuator 126 drives arm assembly 124 to rotate between a lowered position and a raised (dump) position as part of a manual or automated dump cycle. In one exemplary dump cycle, front lift 118, via fork assembly 128, engages a waste container 222 located on the ground in front of the cabin 107. Next, front lift 118 lifts waste container 222 above cabin 107 by driving arm assembly 124 to rotate via arm actuator 126. Front lift 118 then dumps the contents of waste container 222 into storage container 120 by rotating fork assembly 128 with the fork actuator. The waste container 222 can be, for example, a dumpster or a carry can.

In some examples, a carry can is deployed on the front lift 118. The carry can includes a side loader assembly that is configured to load refuse into the carry can and can include substantially any suitable actuated grabber mechanism for grabbing a refuse container and an arm configured to move the grabber in and out and up and down with respect to the carry can.

Additional operational components of refuse collecting body 108 include a packer 170 for packing waste within storage container 120, a pivoting tailgate 112 for controlling access to an opening of storage container 120, and an ejector actuator 175 for moving the packer 170 to pack the waste material in the storage container 120 and expel waste from storage container 120 when tailgate 132 is pivoted upward to an open position.

Vehicle 200 can include a suite of sensing devices 134 (e.g., sensors and/or detectors) monitoring the state of the surrounding environment and/or the state of the operational components of chassis 101 and body 108. Sensing devices 134 are responsive to physical stimuli associated with the monitored aspect of the environment or operational components and output corresponding digital or analog data signals. The data signals from sensing devices 134 are communicated to an onboard control system 400 in the cabin 107 of vehicle 200. Onboard control system 400 processes the data signals to determine the state of the monitored environment or operational component, e.g., the presence of an external object (e.g., a residential or commercial waste container), the relative position of an element of the front lift 118, or the status of an onboard battery or fuel source.

The refuse collection vehicle 200 includes a plurality of actuators deployed throughout the refuse collecting body 108 and configured to actuate various body components (e.g., tailgate, refuse packer, and refuse loading assembly). The actuators of the refuse collecting body 108 can be custom-made for the specific power, force, speed, and displacement required to move the components of the refuse collecting body 108.

The actuators can be in two-way electronic communication with an onboard control system 400. The control system 400 is configured to receive and process sensor data from one or more communication systems during a refuse collection operation. As described in more detail below, the data may be processed, for example, in real time during a refuse collection operation to automatically adjust operating parameters of the actuators and/or to provide feedback/coaching to the driver via a driver interface. Automatic improvement may be realized, for example, via controlling actuator speed or pressure. Driver-controller packer operation may also be improved, for example, by providing real time instructions/coaching to promote improved packer operation.

FIG. 2B illustrates an example side-loader refuse collection vehicle 250. Refuse collection vehicle 250 includes a refuse collecting body 252. Refuse collection vehicle 250 further includes a side loader assembly 260 configured to load refuse into a hopper 300 of a refuse storage container 120. The storage container 120 is supported by the wheeled chassis 101. The side loader assembly 260 can include substantially any suitable actuated grabber mechanism 260a (for grabbing a refuse container) and an actuated side loader arm 260b (configured to move the grabber in and out and up and down with respect to the refuse collecting body 252).

Refuse collection vehicle 250 includes a packer 270 (also referred as an ejector panel, an ejector, and a packer panel, among other terms) deployed in the refuse collecting body 252 within the refuse storage container 120. The packer 270 is disposed within the refuse storage container 120 and is configured to translate between forward (retracted) and rearward (extended) positions in a direction substantially parallel with a longitudinal axis of the refuse collecting body 252 of the refuse collection vehicle 250. The refuse collection vehicle 250 further includes an ejector actuator 275 configured to translate the packer 270 between the retracted and extended positions. The ejector actuator 275 is attached to the packer 270 to move the packer 270. The ejector actuator 275 moves the packer 270 to pack the waste material by retracting or extending an arm of the actuator 275. The vehicle may include substantially any suitable ejector actuator 275.

The ejector actuator 275 can be, for example and without limitation, a ball screw actuator, a lead screw actuator, or a rotary style actuator. For example, the ejector actuator 275 can be a linear actuator. In the case of a linear actuator, the ejector actuator 275 can push, by extending an arm of the actuator 226, the packer 270. The ejector actuator 275 can be an electric or hydraulic actuator.

The packer 270 is generally retracted towards the front of the vehicle 250 while the vehicle 250 is collecting refuse into the hopper 300, for example, via a side loader assembly 260. For example, as depicted in FIG. 2B, the packer 270 is retracted to the front of the storage container 120 (adjacent to the cab) while refuse is collected in the hopper 300. When the hopper 300 is full (or at any other suitable time determined by the operator), the packer 270 can be actuated toward the rear of the vehicle 250 to empty the hopper 300 and compact the refuse into the refuse storage container 120. In some examples, the packer 270 is configured to automatically compact the refuse after a designated number of loads has been picked up by the refuse collection vehicle 250.

In some implementations, some of the body components shown in FIGS. 2A and 2B can be electrically actuated and some of the body components can be hydraulically actuated. Hydraulic actuation can be accomplished with a local oil reservoir or with a larger oil reservoir that serves multiple hydraulic actuation points. In some examples, a pump with an electric motor can be used to pressurize the hydraulic system and actuate the hydraulic actuators.

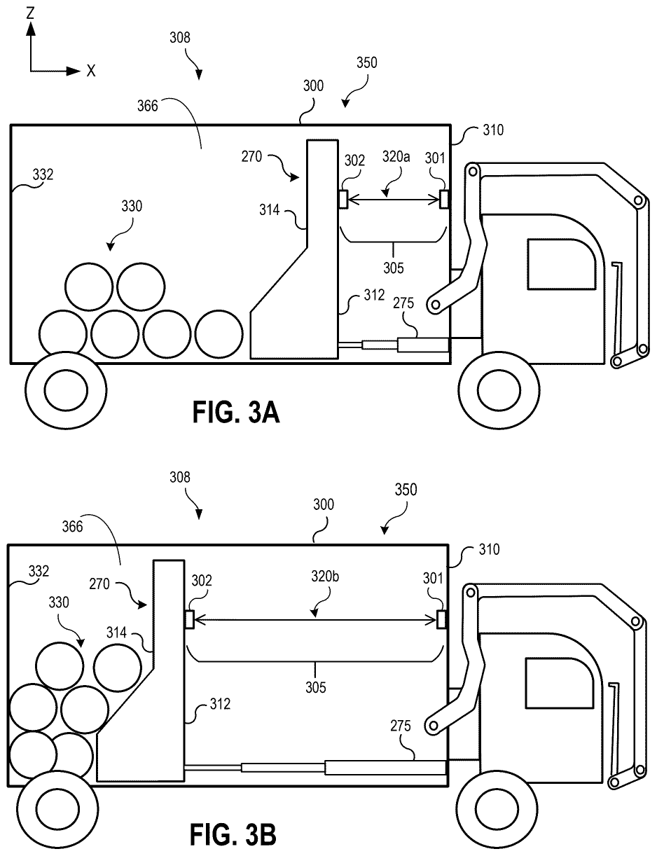

FIGS. 3A and 3B are side views of a refuse collection vehicle 350 with a packer 270 operating to pack refuse within a storage container 366 of the refuse collection vehicle 350. The refuse collection vehicle 350 includes a refuse collecting body 308. FIG. 3A shows the packer 270 in a less-extended position nearer to a front wall 310 of the storage container 366. FIG. 3B shows the packer 270 in a more-extended position further from the front wall 310 of the storage container 366. By operating actuator 275 to extend and push the packer 270 towards the tailgate 332, as depicted in FIG. 3B, the packer 270 pushes refuse within the storage container 366 rearwards towards the tailgate 332 of the vehicle 350.

The vehicle 350 includes a communication system 305 disposed inside the storage container 366. The communication system 305 can include a communication system. In some examples, the communication system 305 includes a first communication device 301 attached to a wall 310 of the storage container 366. The communication system 305 includes a second communication device 302 attached to a surface 312 of the packer 270 and facing the wall 310 of the storage container 366. The communication system 305 is configured to generate data indicating a distance 320a, 320b between the surface 312 of the packer 270 and the wall 310.

The vehicle 350 includes an actuator 275 disposed between the wall 310 of the storage container 366 and the surface 312 of the packer 270. The actuator 275 is coupled to the packer 270. The actuator 275 is configured to exert a force on the packer 270 to move the packer 270. The actuator 275 can move the packer 270 away from the wall 310 and towards the wall 310 along the x-dimension.

During operation, refuse 330 is released into the hopper 300 of the storage container 366 while the packer 270 is in an initial position near the wall 310. To push the refuse 330 towards the rear of the vehicle 350 and/or to eject the refuse 330 from the rear of the vehicle 350, the actuator 275 extends to move the packer 270 away from the wall 310. To return the packer 270 to the initial position, the actuator 275 moves the packer 270 towards the wall 310. In some examples, multiple actuators 275 are configured to move the packer 270 away from and towards the wall 310.

Referring to FIG. 3A, the second communication device 302 of the communication system 305 is a first distance 320a from the first communication device 301. Referring to FIG. 3B, the actuator 275 is extended to move the packer 270 away from the wall 310. As the actuator 275 extends, the packer 270 pushes the refuse 330 towards the rear of the vehicle 350. At the extended position shown in FIG. 3B, the second communication device 302 is a second distance 320b from the first communication device 301, where the second distance 320b is greater than the first distance 320a.

In some examples, the communication system 305 is configured to transmit and receive electromagnetic energy (e.g., radio frequency energy). In some examples, the communication system 305 is configured to transmit and receive ultra-wide band electromagnetic energy. In some examples, the communication system 305 is configured to transmit and receive ultrasonic energy.

Ultra-wide band (e.g., UWB, ultra-wide band, ultraband) is a short-range wireless communication protocol. Ultra-wideband is based on the IEEE 802.15.4a and 802.15.4z standards that can enable the very accurate measure of the Time of Flight of the radio signal, resulting in distance and location measurements with high accuracy. Ultra-wide band uses radio waves to enable devices such as the first communication device 301 and the second communication device 302 to communicate with each other.

In general, ultra-wide band energy in the form of a radio pulse is transmitted from one device to another across a distance, and the time for the radio pulse to travel between devices is measured. The frequency range of ultra-wide band is between 3.1 and 10.6 GHz. An ultra-wide band transmitter can send up to one billion pulses per second (e.g., about one pulse per nanosecond). Ultra-wide band energy uses low power, and can be powered by a small battery for long periods of time.

The high bandwidth can be used to deliver a large amount of data from an ultra-wide band transmitter to a receiver. By sending pulses in patterns, the ultra-wide band transmitter encodes information. A time to encode a single bit of data can be between about thirty and one hundred-twenty pulses, enabling data rates of seven to twenty-seven megabits per second. Ultra-wide band energy can thus be used to obtain measurements quickly (e.g., a thousand times faster than Bluetooth).

Ultra-wide band electromagnetic energy can be used to measure distances with high accuracy. In some examples, measurements using ultra-wide band energy can be accurate to millimeters or centimeters. Due to the higher frequencies and large bandwidth, Ultra-wide band electromagnetic energy is less susceptible to interference compared to energy at other frequencies such as cellular communications, global positioning system (GPS) signals, Bluetooth, ZigBee, and WiFi. Therefore, measurements using ultra-wide band electromagnetic energy can be accurate even when objects obstruct the transmission path of the electromagnetic energy. For example, refuse can enter the portion of the hopper 300 between the packer 270 and the wall 310, and the communication system 305 can continue to accurately measure the distance of the packer 270 from the wall 310 even when refuse is in between the first communication device 301 and the second communication device 302. Ultra-wide band energy is also less susceptible to interference caused by other energy signals.

In some examples, the first communication device 301, the second communication device 302, or both, include a transceiver that is capable of both transmitting and receiving communications. In some examples, the first communication device 301, the second communication device 302, or both, include an ultra-wide band transceiver.

In some examples, the first communication device 301 and the second communication device 302 each include a transceiver. For example, the first communication device 301 can function as an “anchor,” with a fixed location relative to the refuse collecting body 308. The second communication device 302 can function as a “tag,” with a variable location relative to the refuse collecting body 308. The anchor and tag exchange information to establish the distance between them. In some examples, the first communication device 301 and the second communication device 302 can switch roles, alternately functioning as tag and anchor.

In some examples, the distance between the first communication device 301 and the second communication device 302 can be determined using a two-way ranging process. During a two-way ranging process, the second communication device 302 (functioning as a tag) sends a first electromagnetic signal, or poll signal, to the first communication device 301 (functioning as an anchor). The first communication device 301 records the time of receipt of the poll signal, and sends a second electromagnetic signal, or response signal, to the second communication device 302. The second communication device 302 receives the response signal and calculates the time of flight between communication devices based on the signal round-trip time and the reply time (e.g., the time that it took for the first communication device 301 to process and reply to the poll signal). For example, the time of flight can be determined by subtracting the reply time from the round-trip time, and dividing the result by two.

The distance between the first communication device 301 and the second communication device 302 can be determined by multiplying the time of flight by the speed of light. In some examples, the second communication device 302 calculates the distance and sends the calculated distance to the control system 400. In some examples, the second communication device 301 sends time of flight information to the control system 400, and the control system determines the distance between the first communication device 301 and the second communication device 302. In some examples, the first communication device 301 and the second communication device 302 send information to the control system 400 indicating the time of transmitting and receiving the poll signal and reply signal, and the control system 400 determines the distance between the first communication device 301 and the second communication device 302.

In some examples, the first communication device 301 is a transmitter and the second communication device 302 is a receiver. For example, the first communication device 301 can be configured to transmit electromagnetic energy to the second communication device 302, and the second communication device 302 can be configured to transmit, to the control system, time data associated with the electromagnetic energy. For example, the first communication device 301 can transmit electromagnetic pulses to the second communication device 302. The first communication device 301 can transmit the electromagnetic pulses continuously, continually, or repeatedly. Each pulse can be encoded with information indicating a time of transmission of the pulse. The second communication device 302 can receive the pulse and determine a time of receipt of the pulse. The second communication device 302 can determine a travel time of the pulse from the first communication device 301 to the second communication device 302 based on the time duration between the time of transmission and the time of receipt of the pulse. The second communication device 302 can output, to the control system, data indicating the travel time of the pulse. The control system can determine a distance of the packer 270 from the wall 310 based on the travel time of the pulse.

In another example in which the first communication device 301 is a transmitter and the second communication device 302 is a receiver, the first communication device 301 transmits an electromagnetic pulse and provides data to the control system indicating a time of transmission of the pulse. The second communication device 302 receives the electromagnetic pulse and provides data to the control system indicating a time of receipt of the pulse. The control system can determine a travel time of the pulse from the first communication device 301 to the second communication device 302 based on the time of transmission indicated by the first communication device 301 and the time of receipt indicated by the second communication device 302. The control system can determine a distance of the packer 270 from the wall 310 based on the travel time of the pulse.

In some examples, the first communication device 301 is a receiver and the second communication device 302 is a transmitter. For example, the second communication device 302 can be configured to transmit electromagnetic energy to the first communication device 301, and the first communication device 301, the second communication device 302, or both can be configured to transmit, to the control system, time data associated with the electromagnetic energy. In some examples, the first communication device 301 and the second communication device 302 each include a transceiver and can switch roles, alternately functioning as transmitter and receiver.

Although described as measuring a distance 320 between the surface 312 of the packer 270 and the front wall 310 of the storage container 366, a communication system can be configured to measure and/or determine other distances in addition to or instead of the distance 320 between the surface 312 of the packer 270 and the front wall 310 of the storage container 366.

In some examples, the control system 400 can determine the distance between the packer 270 and a tailgate 332 based on the distance between the first communication device 301 and the second communication device 302. For example, the control system 400 can subtract the distance 320 and a width of the packer 270 from a total distance between the front wall 310 and the tailgate 332 in order to determine the distance between the packer 270 and the tailgate 332.

In some examples, a communication system 305 is configured to measure a distance between the packer 270 and a tailgate 332 of the vehicle 350. For example, the first communication device 301 can be positioned at a rear of the refuse collecting body 308 opposite from the front wall 310, The first communication device 301 can be attached, for example, to an interior surface of a tailgate 332 of the refuse collecting body 308. The second communication device 302 can be attached to a surface 314 of the packer 270. The first communication device 301 and the second communication device 302 can communicate with each other in order to determine a distance between the tailgate 332 and the packer 270.

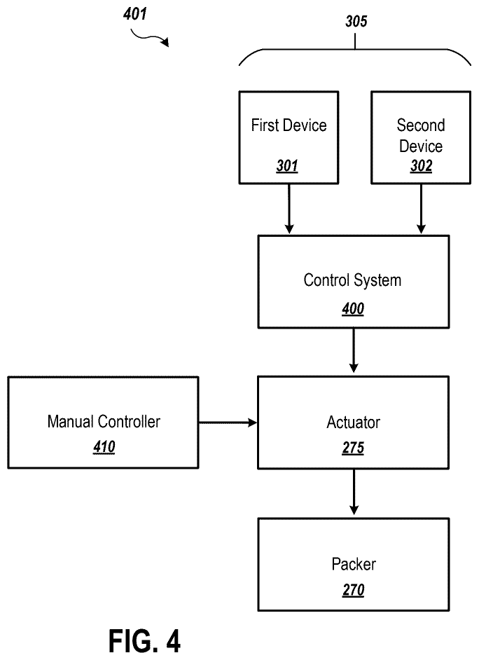

Referring to FIG. 4, the control system 400 can adjust operating parameters of the actuator 275 based on the distance between the surface 312 of the packer 270 and the front wall 310 of the storage container 366 determined based on signals generated by the communication system 305. In some examples, the control system 400 can operate the actuator 275 such that a force applied by the actuator 275 to the packer 270 is less when the distance between the surface 312 of the packer 270 and the front wall 310 of the storage container 366 is greater. For example, the actuator 275 can be controlled to apply a lesser force to the packer 270 in FIG. 3B than in FIG. 3A, due to the distance 320b between the first communication device 301 and the second communication device 302 being greater in FIG. 3B than in FIG. 3A. By decreasing the amount of force applied to the packer 270 when the packer 270 is a greater distance from the wall 310, the likelihood of damaging the actuator 275 due to overextension of the actuator 275 can be reduced.

In some examples, the control system 400 can adjust operating parameters of the actuator 275 based on a distance traveled by the packer 270 during a single displacement of the packer 207 away from the wall 310 of the storage container 366. For example, the actuator 275 can extend to move the packer 270 away from the wall 310, and the control system 400 can adjust operating parameters of the actuator 275 based on the real-time distance traveled by the packer 270 as the packer 270 moves away from the wall 310, such as by reducing an amount of force applied by the actuator 275 as the distance traveled increases.

In some examples, the control system 400 can adjust operating parameters of the actuator 275 based on a distance traveled by the packer 270 during multiple displacements from the wall 310 of the storage container 366. For example, during a truck route, the packer 270 can be moved multiple times to compress the refuse 330 in the storage container 366. The control system 400 can track a total distance traveled by the packer 270 using data from the communication system 305. A total distance traveled by the packer 270 can be an indication of an amount of refuse 330 collected by the vehicle 350.

For example, as refuse 330 accumulates in the storage container 366, the packer 270 repeatedly moves away from and towards the wall 310 in order to compress the refuse 330. Thus, a greater cumulative amount of travel distance of the packer 270 over a collection route can indicate that a greater amount of refuse 330 has been collected by the vehicle 350. When refuse has accumulated in the storage container 366, a full extension of the actuator 275 might not be needed in order to compress the refuse 330 within the storage container 366. The control system 400 can adjust operating parameters of the actuator 275 based on the real-time total distance traveled by the packer 270 as the packer 270 moves towards and away from the wall 310 throughout the truck route, such as by reducing an amount of force applied by the actuator 275 as the cumulative distance traveled by the packer 270 increases during a route. This can reduce the likelihood of damaging the actuator 275 as refuse 330 accumulates and becomes more difficult to compress.

In some examples, the measurement of the cumulative distance traveled by the packer 270 can be reset at designated times and/or in response to detection of designated events. For example, the measurement of the cumulative distance traveled by the packer 270 can be reset in response to detecting that the tailgate 332 is raised, since raising the tailgate 332 is an indication that the storage container 366 is likely being emptied. The control system 400 can detect that the tailgate 332 is raised, for example, based on sensor data generated by the sensing devices 134. In some examples, the measurement of the cumulative distance traveled by the packer 270 can be reset in response to the refuse collection vehicle 350 being at a particular location and/or moving in a particular direction. For example, the measurement of the cumulative distance traveled by the packer 270 can be reset in response to the refuse collection vehicle 350 departing from a refuse collection facility. The control system 400 can determine that the refuse collection vehicle 350 is departing from the refuse collection facility, for example, based on GPS data indicating a location of the refuse collection vehicle 350.

FIG. 4 is a block diagram of an example packer system 401 a refuse collection vehicle. The packer system 401 includes a communication system 305. The communication system 305 includes the first communication device 301 and the second communication device 302. The packer system 401 includes a control system 400, a manual controller 410, the actuator 275, and the packer 270.

In some examples, the control system 400 includes a programmable logic controller (PLC). The control system 400 is configured to receive data as input from the first communication device 301, the second communication device 302, or both. The data includes signals indicating the distance of the packer 270 from the wall 310 of the storage container 366. In some examples, the control system 400 receives data indicating a travel time of electromagnetic energy between the first communication device 301 and the second communication device 302, and determines the distance of the packer 270 from the wall 310 based on the travel time.

The control system 400 operates the actuator 275 based on the distance of the packer 270 from the wall 310 determined based on the signals received from the first communication device 301 and/or the second communication device 302. For example, the control system 400 can adjust operating parameters of the actuator 275 to increase or decrease the amount of force applied by the actuator 275 to the packer 270 based on the distance between the packer 270 and the wall 310 of the storage container 366.

In some examples, the control system 400 adjusts parameters of the actuator 275 in response to receiving a signal from the communication system 305. In some examples, the control system 400 includes multiple communication systems 305 and can apply coincidence logic that requires signals from one or more communication systems 305 before adjusting operating parameters of the actuator 275.

The packer system 401 can include any number of communication systems 305, e.g., one communication system, two communication systems, three communication systems, or four communication systems. Each communication system includes at least two communication devices (e.g. a transmitter and receiver, a transmitter and a transceiver, a transceiver and a receiver, two or more transceivers, or any combination thereof). The control system 400 can be configured to adjust parameters of the actuator 275 in response to receiving signals from, e.g., one out of one communication systems, one out of two communication systems, two out of two communication systems, two out of three communication systems, two out of four communication systems, three out of four communication systems, etc.

In some examples, the control system 400 adjusts operating parameters of the actuator 275. In some examples, the actuator 275 is a hydraulic actuator. The refuse collection vehicle can include a valve system fluidly coupled to the actuator 275, and the valve system can be controllable by the control system 400 to reduce or increase a pressure of hydraulic fluid in the actuator 275. Changing the pressure of the hydraulic fluid causes a change in the force exerted by the actuator 275 on the packer 270. In some examples, the control system 400 adjusts a setting of a pressure relief valve of the valve system based on the distance of the packer 270 from the wall 310. For example, when the distance of the packer 270 from the wall 310 satisfies a threshold distance, the setting of the pressure relief valve can be adjusted to a lower pressure to reduce the amount of hydraulic force applied by the actuator 275 to the packer 270. The reduction of the pressure setting of the relief valve can be, for example, forty percent less than an initial pressure setting. The reduction in the pressure setting can reduce the amount of packing force applied by the packer 270 to the refuse 330, allowing the packer 270 to compress the refuse 330 with a reduced packing force when the distance between the packer 270 and the refuse 330 is above a threshold distance.

In some examples, the actuator 275 is a linear actuator. A linear actuator applies a push-pull force. In some examples, a linear actuator converts rotary motion into linear motion.

In some examples, the actuator 275 is additionally or alternatively controllable by a manual controller 410. The manually controller 410 can be located at a cabin of the refuse collection vehicle 350. In some implementations, the control system 400 can be configured to override the manual controller 410 to control the actuator 275 independent from the manual controller 410. In some implementations, the manual controller 410 can be configured to override the control system 400 to control the actuator 275.

In some implementations, the control system is a computer software routine configured to perform a particular task or particular tasks (e.g., related to vehicle power management). The routine can run, for example, on an onboard computer. The module may likewise refer to a platform including a combination of dedicated hardware and software configured to perform various tasks (e.g., the vehicle power management tasks in the disclosed implementations). Such hardware can include one or more processors and dedicated memory and can be in communication with or incorporated into the onboard computer.

In some implementations, an electric hydraulic pump can be used in place of one or more actuators. The electric hydraulic pump receives power from a battery pack and pressurizes a hydraulic system to actuate a hydraulic actuator. The onboard vehicle computer system can communicate with and control hydraulic actuators via the electric hydraulic pump.

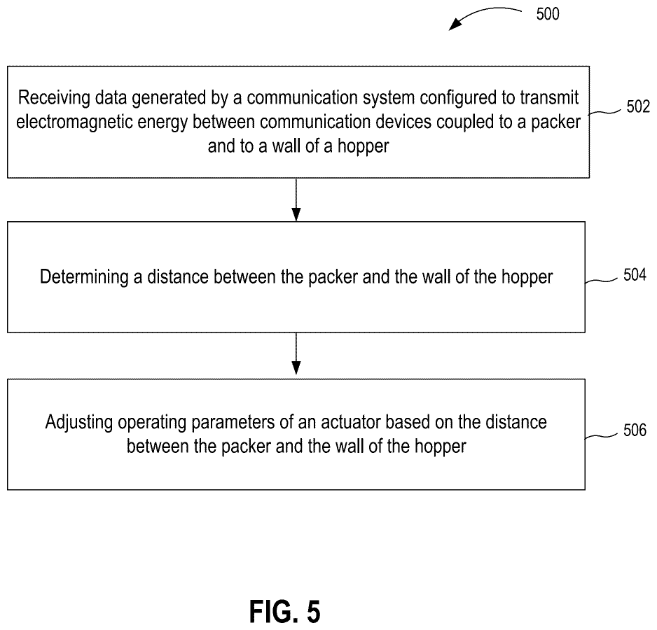

FIG. 5 is a flow chart of an example method 500 of operating a refuse collecting body of a refuse collection vehicle (e.g., refuse collection vehicle 100, 200, 250, 280).

The method 500 can be implemented by, for example, a controller or onboard computer system (e.g., control system 400). Steps of the method 500 may occur in the illustrated sequence, or in a sequence that is different from the illustrated sequence. For example, some of the steps may occur concurrently.

The control system receives data generated by a communication system configured to transmit electromagnetic energy between communication devices coupled to a packer and to a wall of a hopper (502). The communication system 305 includes the first communication device 301 attached to the wall 310 of the storage container 366 and the second communication device 302 attached to the surface 312 of the packer 270 and facing the wall 310 of the storage container 366. The electromagnetic energy can be radio frequency energy. In some examples, the electromagnetic energy is ultra-wide band electromagnetic energy.

The control system determines a distance between the packer and the wall of the hopper (504). The control system can determine the distance between the packer 270 and the wall 310 of the storage container 366 based on the data generated by the communication system 305. In some implementations, the control system causes the distance between the packer and the wall of the hopper to be displayed on a display device. The display device can be located, for example, in a cabin of the refuse collection vehicle.

The control system adjusts operating parameters of an actuator based on the distance between the packer and the wall of the hopper (506). The actuator 275 is coupled to the packer 270 and is configured to exert a force on the packer 270 to move the packer 270 within the storage container 366. The control system can generate one or more control signals to control actuation of the actuator 275 according to the adjusted operating parameters. In some examples, the control system adjusts operating parameters of the actuator 275 such that the actuator exerts a force on the packer 270 below a threshold force when the distance of the packer 270 from the wall 310 of the storage container 366 is greater than a threshold distance.

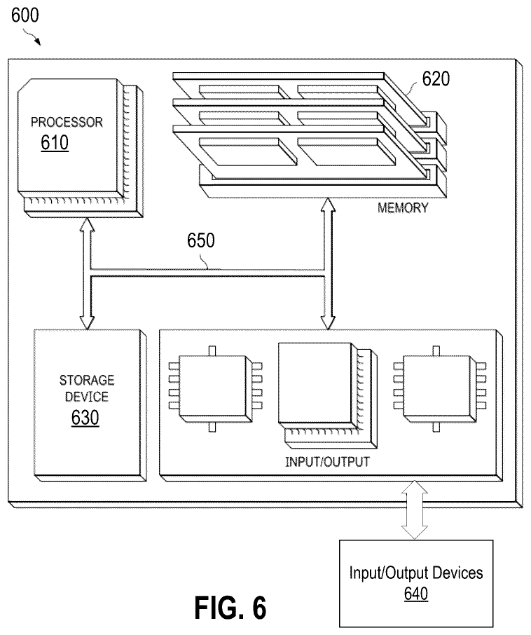

FIG. 6 is a schematic illustration of an example control system or controller for a waste collection vehicle according to the present disclosure. For example, the controller 600 may include or be part of the onboard computer system. The controller 600 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 600 includes a processor 610, a memory 620, a storage device 630, and an input/output device 640. Each of the components 610, 620, 630, and 640 are interconnected using a system bus 650. The processor 610 is capable of processing instructions for execution within the controller 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the controller 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the controller 600. In one implementation, the storage device 630 is a computer-readable medium. In various different implementations, the storage device 630 may be a floppy disk device, a hard disk device, an optical disk device, or a tape device.

The input/output device 640 provides input/output operations for the controller 600. In one implementation, the input/output device 640 includes a joystick. In some implementations, the input/output device 640 includes a display unit for displaying graphical user interfaces. For example, in some implementations, the input/output device 640 is a display device that includes one or more buttons and/or a touchscreen for receiving input from a user. In some implementations, the input/output device 640 includes a keyboard and/or a pointing device. In some implementations, the input/output device 640 is located within a cab of a refuse collection vehicle (e.g., within cabin 107 of vehicle 100). For example, the input/output device 640 can be attached to or incorporated within a dashboard inside the cab of a refuse collection vehicle.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device.

Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

By real time it is meant that energy data collected during a collection operation (e.g., the vehicle's performance of a refuse collection route) is processed to provide automatic control or to adjust operating parameters during the same operation (e.g., during the same refuse collection route). The timeliness may depend, for example, on the quantity of data collected, the complexity of the processing, and whether or not cloud processing is implemented. In some implementations, real time can mean within 1 second, 1 minute, 5 minutes, 10 minutes, 30 minutes, 1 hour, or two hours.

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

What is claimed is:

1. A method of operating a refuse collection vehicle, the method comprising:
receiving, by a control system, data generated by a communication system configured to transmit and receive electromagnetic energy, the communication system comprising:
a first communication device attached to a wall of a storage container of the refuse collection vehicle; and
a second communication device attached to a surface of a packer of the refuse collection vehicle and facing the wall of the storage container;
determining, by the control system and based on the data generated by the communication system, a distance between the packer and the wall of the storage container; and
adjusting, by the control system and based on the distance between the packer and the wall, one or more operating parameters of an actuator coupled to the packer and configured to exert a force on the packer to move the packer.

2. The method of claim 1, wherein adjusting the one or more operating parameters of the actuator comprises controlling the actuator to exert a force on the packer below a threshold force when the distance between the packer and the wall of the storage container is greater than a threshold distance.

3. The method of claim 1, wherein adjusting the one or more operating parameters of the actuator comprises controlling the actuator to exert a force on the packer below a threshold force when the distance between the packer and the wall of the storage container is less than a threshold distance.

4. The method of claim 1, comprising:
operating the actuator to exert a first force on the packer;
receiving, by the control system from the communication system, updated data;
determining, by the control system and based on the updated data, a distance traveled by the packer;
determining that the distance traveled by the packer satisfies a threshold distance; and
in response to determining that the distance traveled by the packer satisfies the threshold distance, operating the actuator to exert a second force on the packer, the second force being less than the first force.

5. The method of claim 4, wherein the distance traveled by the packer comprises:
a distance traveled by the packer during a single displacement from the wall of the storage container, or
a distance traveled by the packer during multiple displacements from the wall of the storage container.

6. The method of claim 1, wherein the first communication device comprises a first radio frequency transceiver and the second communication device comprises a second radio frequency transceiver.

7. The method of claim 1, wherein the first communication device comprises a radio frequency transmitter and the second communication device comprises a radio frequency receiver.

8. The method of claim 1, wherein the first communication device comprises a radio frequency receiver and the second communication device comprises a radio frequency transmitter.

9. The method of claim 1, wherein the communication system is configured to transmit and receive ultra-wide band frequency electromagnetic energy.

10. The method of claim 1, wherein the electromagnetic energy has a frequency between 3.0 GHz and 11.0 GHz.

11. The method of claim 1, wherein receiving, by the control system, the data generated by the communication system comprises:
receiving, from the communication system, data indicating a time duration between electromagnetic energy transmission and electromagnetic energy receipt.

12. The method of claim 1, wherein receiving, by the control system, the data generated by the communication system comprises:
receiving, from the communication system, data indicating a time duration between:
transmission of electromagnetic energy from the second communication device to the first communication device; and
receipt of electromagnetic energy by the second communication device from the first communication device.

13. The method of claim 1, wherein:
the first communication device comprises a first ultra-wide band transceiver;
the second communication device comprises a second ultra-wide band transceiver;
the first ultra-wide band transceiver is configured to transmit electromagnetic energy to the second ultra-wide band transceiver; and
the second ultra-wide band transceiver is configured to transmit, to the control system, time data associated with the electromagnetic energy.

14. The method of claim 1, wherein:
the actuator comprises a hydraulic actuator;
the refuse collection vehicle further comprises a valve system fluidly coupled to the actuator; and
adjusting the one or more operating parameters of the actuator comprises controlling, by the controller, a pressure of hydraulic fluid in the actuator to alter the force exerted by the hydraulic actuator on the packer, including adjusting a setting of a pressure relief valve of the valve system based on the distance of the packer from the wall.

15. The method of claim 1, wherein the actuator comprises a linear actuator.

16. The method of claim 1, comprising operating, by the control system, two or more actuators based on the distance between the packer and the wall.

17. The method of claim 1, wherein the actuator is coupled to the wall of the storage container and to the surface of the packer.

18. The method of claim 1, wherein the actuator comprises an electric actuator or a hydraulic actuator.

19. A refuse collection vehicle, comprising:
a wheeled chassis;
a storage container supported on the wheeled chassis;
a packer disposed within the storage container;
an actuator coupled to the packer and configured to exert a force on the packer to move the packer;
a communication system configured to generate data indicating a distance of the packer from a wall of the storage container, the communication system comprising:
a first communication device attached to the wall of the storage container; and
a second communication device attached to a surface of the packer and facing the wall of the storage container; and
a control system configured to receive, as input, the data indicating the distance of the packer from the wall of the storage container and to adjust one or more operating parameters of the actuator based on the distance between the packer and the wall of the storage container.

20. A method of operating a refuse collection vehicle, the method comprising:
receiving, by a control system from a communication system, data indicating time-varying distance of a packer of the refuse collection vehicle from a wall of a storage container of the refuse collection vehicle, the communication system comprising:
a first communication device attached to the wall of the storage container; and
a second communication device attached to a surface of the packer and facing the wall of the storage container;
determining, by the control system and based on the received data, a distance traveled by the packer over a time duration; and
adjusting, by the control system and based on the distance traveled by the packer over the time duration, one or more operating parameters of an actuator coupled to the packer and configured to exert a force on the packer to move the packer.
